(19) United States
(12) Patent Application Publication
(10) Pub. No.: US 2014/0279343 A1
(43) Pub. Date: Sep. 18, 2014

(54) STREAMING PRODUCTION OF AGRICULTURAL COMMODITIES

(71) Applicant: Input Capital Corp., Regina (CA)

(72) Inventors: Brad Farquhar, Regina (CA); Doug Emsley, Regina (CA); Gord Nystuen, Regina (CA); Patricia Warsaba, Regina (SK)

(21) Appl. No.: 13/837,156

(22) Filed: Mar. 15, 2013

(51) Int. Cl. G06Q 40/04; G06Q 50/02

(52) U.S. Cl. CPC G06Q 40/04; G06Q 50/02
USPC 705/37

(57) ABSTRACT

A novel method for financing in production of agricultural commodities. A contractual framework between the agricultural producer and a capital provider is defined by consideration of a minimum guaranteed yield and net price for the crop within a particular crop season. Before the commencement of a crop growing season, the parameters of a crop cycle including a guaranteed minimum yield and a net price are generated by a crop production computer software program, and are agreed between the farmer and the capital provider. During the growing season the capital provider pays for all of the required crop inputs while the farmer grows the crop. At the conclusion of the growing season, the farmer delivers the crop production to the capital provider and is paid the agreed net price in respect of the complete volume produced, hedged by the guaranteed minimum yield. The net payment due to the farmer can also be calculated by the crop production computer software.

### TECHNICAL FIELD

This invention is in the field of agricultural crop production, and more particularly deals with a method of production between a farmer and a capital provider that provides for crop maximization and guaranteed return to the farmer with the capital provider financing crop inputs during the growing season.

### BACKGROUND OF THE INVENTION

There are a number of different principles in agricultural crop production which have over the past number of years made this a more economically challenging business for farmers. The first of these phenomena has been the increasing size of farms which, while offering some economies of scale, has increased the capital requirements to farm efficiently as the size of crop production areas increases. From the need to acquire more land to farm with a competitive cost structure alongside other producers, to the cost of larger and more sophisticated equipment, more capital is required by the farmer to execute a crop cycle.

Beyond the capital costs of land and equipment, the cost of crop inputs also increases alongside the size of a farm, and the need to finance or prepay for crop inputs throughout the course of the growing year makes the economics of farming challenging again and increases the capital requirements or the need for credit worthiness at a higher level on the part of the farmer to produce their crops economically and efficiently. The economic requirements and risks of farming field crops in the current environment then is potentially a problem, or alternatively an opportunity, that it might be desirable to try and deal with.

Enhanced or continually improving agronomic practices offer ongoing opportunity in terms of maximizing crop output and profitability for the farmer—the counter to the benefit of enhanced or crop maximizing agronomic practices is that in many cases to employ these practices additional equipment or inputs are required, thus further increasing or exacerbating the capital risk that the farmer must undertake to maximize crop production.

Traditional credit facilities for agricultural operations such as these have consisted of credit facilities from banks or other financial institutions, or in certain cases vendor financing can be acquired with respect to certain crop inputs to allow the farmer to defer payment until their crop is completed. Both in the case of banks or financial institutions, which traditionally have been more risk-averse, as well as with trade financing on inputs, the cost of capital in these circumstances may not the most efficient. The risk profile of agricultural ventures for financial institutions typically mandates the factoring of some risk into the cost of credit facilities, and in the case of vendor financing of crop inputs while the requirement for payment for the inputs would not be typically subject to the outcome of crop year the vendor is going to factor the risk of a crop failure amongst other risks into the setting of the interest rate in those types of transactions. Thus even in circumstances where credit to cover the crop production costs is available it may not be available at the most efficient rate. Enhancing the economic productivity or efficiency of crop production operations by provision of the most cost-efficient credit mechanism would be desirable and well received in the agricultural industry.

Continually improving agronomic practices, as outlined above, or on an ongoing basis allowing farmers to produce crops more efficiently and in maximized or higher volumes on their land. A rate limiting step on occasion in the adoption of these agronomic practices may be the capital cost, either to buy different equipment or crop inputs for practicing these methods or even simply the cost of conversion to the new practice from the existing one used at a particular farming operation. Development of a model that would make available the necessary capital to deploy industry-leading, yield enhancing agronomic practices would also be relevant and well received it is believed in the agricultural industry.

Crop production is also susceptible to crop failure or risk based on weather or other potentially unforeseen factors during a crop production season. If it were possible from the perspective of the farmer to lock in or guarantee at least a baseline of revenue from a crop production season they could both personally as well as from the perspective of their business enable some additional business decisions to be made, if they had any guarantee of some revenue with respect to a particular crop or crop production season. It is believed that a crop production method that provided some basis for a minimum revenue guarantee would be well received in agricultural industries as well, particularly if it also accommodated or provided a mechanism for the capital requirements of the farming operation and the use of up-to-date agronomic practices.

An economic model for crop production which made available economically efficient, risk tolerant capital for crop production purposes, while providing a revenue model for the farmer with some baseline revenue guarantee would, it is believed, be well accepted in the agricultural sector, in addition to providing an investment product with a tolerable risk profile for investors to capitalize such a product. Similar projects, and project profiles, have been undertaken in the past in other industries such as mining or other resource exploration—various models which provide for a similar outcome, namely a baseline revenue guarantee for the owner of the property with sufficient upside for both the owner as well as a third party capital provider, have been tested in the past—these collectively have been referred to as “streaming” methods.

The availability of computers and computer software for use in financial models and financial methods has allowed in the past number of years for the creation of many novel business approaches to different economic situations, such as the scenario of the financing of agricultural production outlined above. Creation of computer software for use in the facilitation of an agricultural crop production streaming method would also be desirable insofar as it could further facilitate the adoption and rapid rollout and practice of methods such as the solution outlined or anticipated herein.

### SUMMARY OF THE INVENTION

As outlined above, the present invention is a method of production of agricultural crop within a crop season by a farmer in the capital provider. The method allows for the division of the physical risk and the economic risk associated with crop production between these two parties, basically by having the capital provider cover the input costs of the crop and compensating the farmer based on a formula and a guaranteed revenue stream to actually conduct the production of the crop.

Before commencement of the crop season, crop cycle is defined. The crop cycle consists of a number of parameters being the crop to be grown in a particular crop season on a crop production area. Once the crop cycle has been defined by the selection or determination of these parameters, guaranteed minimum volume yield for the defined crop cycle is determined. This can either be determined arbitrarily or based upon historical information with respect to growth of those crops or those crop production areas. The guaranteed minimum volume yield would be supplemented by the determination or definition of a volume-based net price to be paid to the farmer for crop production from the crop cycle is defined and there would then be a contract relationship created between the farmer in the capital provider for sale of all of the crop produced during that defined crop cycle, wherein the capital provider would agree to pay the net payment to the farmer at the conclusion of the crop cycle which was the greater of the multiplication of the guaranteed minimum volume multiplied by the net per volume price is determined or agreed, or the net price multiplied to the actual volume of crop produced if the actual volume exceeds the guaranteed minimum.

Following determination of these items and contracting of the crop production, the crop season and the crop cycle would commence in the farmer would plant and proceed with production of the crop throughout the crop season in accordance with this arrangement. During the crop cycle the capital provider would pay for all the required crop inputs. This separates a large amount of the capital requirements from the farmer in the production of the crop.

At the conclusion of the crop season, the crop is harvested and would be sold or delivered from the farmer to the capital provider in its entirety—the payment which would be made for the delivery of the crop would be calculated based on the net payment due under the contract which again would represent the greater of the guaranteed minimum yield times the agreed net price, or the actual volume produced times the agreed net price. The payment would be rendered and the capital provider could then proceed to further market or otherwise deal with the produced crop which would be theirs.

The crop cycle could be defined and the guaranteed minimum volume yield and point-based net price to be calculated or recorded using a crop production computer software program. The crop production computer software program can also physically create for execution by the farmer and the capital provider a contract upon completion of the necessary calculations or variable assignments at the front end of the growing season.

The general method contemplates the capital provider paying for all of the required crop inputs in the course of production of the crop. The method can also be modified whereby there would be a Placed on the amount of the required crop inputs and the excess amount paid or spanned could either be paid directly by the farmer during the production year, or could alternatively be deducted by the capital provider from the calculated net payment due at the time of completion of the growing season etc.

The crop cycle parameters could be input into a crop production computer program and the guaranteed minimum volume yield generated on that basis along with the volume-based net price to be paid to the farmer. At the conclusion of the crop season, the crop cycle parameters or details could be recalled by the crop production computer software for the purpose of the final payment calculations.

### DESCRIPTION OF THE DRAWINGS

The present invention is described in further detail below in conjunction with the following Figures, in which the corresponding reference numerals identify corresponding components and method steps:

FIG. 1 is a flowchart demonstrating one basic embodiment of the method of the present invention;

FIG. 2 is a flow chart demonstrating steps conducted in one embodiment of a crop production computer software in the definition and commencement of a crop cycle in accordance with the remainder of the method of the present invention;

FIG. 3 is a flow chart demonstrating steps conducted in one embodiment of a crop production computer software in the calculation and rendering of the final net payment due to the farmer from the capital producer at the conclusion of a crop cycle in accordance with the remainder of the method of the present invention;

FIG. 4 is a block diagram of one computer device which could be used in conjunction with the crop production computer software of the present invention, for demonstrative purposes.

### DETAILED DESCRIPTION OF THE ILLUSTRATED EMBODIMENTS

As outlined above, the present invention is a streaming method for the production of agricultural commodities, which is aided by the use of computer software in the rendering of various necessary calculations and method steps. A farmer would in respect of a particular crop and crop season produce the crop in accordance with agronomic direction provided by the capital provider, who would provide a baseline revenue guarantee as well as finance the cost of crop inputs. The farmer and the capital provider would share the economic upside and profits in terms of crop volume produced beyond the forecast minimum amount contracted at the beginning of the crop cycle.

### Method Overview:

The present invention is a method for streaming the production of agricultural commodities. The concept of streaming of production has been seen in other unrelated industries in the past—for example in mining and the like. Effectively the overarching concept is that the producer makes an agreement with a capital partner to assist in the financing of production from a property, in exchange for which the capital partner provides a minimum net revenue guarantee to the producer, and the producer and the capital partner share in the upside of the production of the property over the minimum net revenue guarantee.

We have modified the concept of streaming production in a mining or resource context to have applicable ability to agricultural operations which repeatedly grow crops on defined crop areas in growth seasons. We believe that this method will have attraction to many agricultural producers who own large quantities of land in so far as it will make the availability of capital easier for them in proper farming and implementation of proper agronomic practices, as well as providing an investment vehicle for capital providers who are interested in participation in a streaming type approach to a cyclical industry such as farming.

For the sake of describing the remainder of the present invention will refer first to FIG. 1 which is a flowchart demonstrating the steps of the novel underlying business method of the present invention, a method of streaming the production of agricultural commodities. Generally speaking the method of the present invention provides for a method of crop production by a farmer with the participation from a financial perspective of a capital provider, to finance the cost of crop production with the profitability of the implementation of this method being shared by the farmer and the capital provider.

The first step in the method of the present invention, shown at Step 1-1, is to define the crop cycle 1 in question. This would take place before the growing season of the crop in question and really relates to defining the parameters of the particular crop production contract or transaction in question. The parameters 1 which are required to be agreed upon by the parties in advance of the implementation of the method of the present invention start with the actual crop season 2. In many cases a crop can be grown once per year and on that basis the crop season 2 in respect of a particular implementation of the method would represent the specific calendar year. Some crops can be grown more than once per year and in that case it may be necessary to stipulate with further detail the crop season 2 to reference a particular cycle within a calendar year. Establishment of agreement on the crop season 2 is important in any event from the perspective of both parties to understand the specific timeframe and crop production which is in question in respect of the method. The crop season 2 which is agreed-upon might actually also represent more than one growth of a crop. For example, if a crop could be grown once every four months, the crop season 2 which was agreed upon from the perspective of the transaction and the underlying agreement might be 12 months, representing three actual physical crops. Different approaches to the crop season such as this will be obvious to those skilled in the art of economics and crop production and all such adjustments and modifications are contemplated within the scope of the present invention.

In addition to the crop season 2, the crop production area 3 needs to be defined. As discussed elsewhere herein, the crop production area 3 is the specific cropping area or field or fields within which the crop in question will be grown pursuant to the method of the present invention. A particular farmer 20 may have more than one crop production area 3 in respect of a crop, or their entire farm may be treated as a single crop production area 3.

Another parameter which will need to be determined is the actual crop 4 itself which is to be grown. Even within a particular type of a crop or field there may be multiple varieties which could be seeded or farmed and it will be necessary for there to be agreement between the farmer 20 and the capital provider 21 what the specific actual crop 4 will be as a founding parameter in the remainder of the implementation of the method.

As will be outlined in further detail elsewhere below it is contemplated that in respect of the relationship between a particular farmer 20 and capital provider 21, a computer software program could be used to store the details of the crops, crop seasons and various crop production areas and those various parameters or available selections could be combined in the creation of certain crop production contracts or transactions in accordance with the remainder of the method of the present invention. It is specifically contemplated that a crop production computer software would be used in the method of the present invention, and its details in terms of processes will be outlined in further detail below.

The next step in the process, following definition of those additional parameters which make up the concept of a crop cycle 1 within the scope of the remainder of this document and the present invention is to generate a guaranteed volume-based minimum yield 5 with respect to the crop and crop production area of the crop cycle 1. This is shown at Step 1-2. Generally speaking the guaranteed minimum yield 5 is the volume of crop for which the farmer will receive baseline profit compensation at the conclusion of the crop cycle 1. The guaranteed minimum yield 5 will be generated by the farmer and the capital provider, likely in conjunction with a crop production computer software again. In a very basic implementation the guaranteed minimum yield 5 could be calculated simply by multiplying a contemplated yield per acre or per unit of measure of the crop production area and multiplying it by the crop production area within the defined crop cycle 1. The crop production computer software may also have additional formulae or data sources connected thereto which would allow for more elaborate calculation or generation of the minimum guaranteed yield 5. In any event the guaranteed minimum yield 5 with respect to the particular crop cycle 1 will be calculated.

The net price 6 represents the amount which would be paid by the capital provider 21 the farmer 20 with respect to the crop output net to the capital financing which would be provided by the capital provider 21 in respect of various crop inputs and costs during the growing season. The net price 6 may be formulaically determined by the computer software of the present invention based upon various environmental parameters or market information and forecasting—the forecasting in relation to the appropriate time window dependent upon the crop season 2, or the net price 6 might also be negotiated between the parties and simply entered into the

[symbol]

It will be understood, and is discussed elsewhere herein, that the establishment of the guaranteed minimum yield 5 and the net price 6 within the contract will be two key economic determinations. In order to agree on these numbers, the capital provider 21 will likely need access to historical crop production data as well as other environmental data with respect to the crop production area 3, since establishment of the guaranteed minimum yield 5, as well as the net price 6, will to a large extent be based upon the past performance and farming practices of the cropping of that particular crop production area 3.

The next step in the method is to calculate or generate a fixed net price per volume—this is shown at Step 1-3. The underlying concept of the present invention is that the capital provider will basically finance all of the crop production inputs in the production of the crop of the crop cycle 1 upon the crop production area and on that basis effectively the fixed net price per volume is a volume-based profit number which is generated and/or agreed upon between the farmer and the capital provider. The farmer will know upon completion of these initial calculations and contracting what the baseline profit is that they will receive for production of a crop in accordance with the crop cycle parameters—because by contract the capital provider will be obligated to pay them a minimum of the guaranteed minimum yield times the net price. The net price will in any event be generated, likely using the crop production computer software, for use in the calculation of this base net payment amount.

Following the generation of the guaranteed volume yield 5 in the net price 6, resulting in the ability to calculate the guaranteed base net payment amount if the guaranteed volume yield is not exceeded by the crop in the crop cycle, a contract will then be generated between the parties in which the farmer will agree to produce the crop in accordance with the crop cycle 1 and parameters defined and agreed between the parties and to deliver all of the crop production to the capital provider at the end of the growth season. The capital provider will agree to pay all of the required crop input costs during the growing cycle and the crop cycle 1, and to provide payment to the farmer at the conclusion of the crop cycle 1 in accordance with the calculation that the farmer would be paid the greater of the guaranteed minimum yield 5 times the net price 6, and the actual delivered yield times the net price 6. The greater of these numbers will constitute the net payment 9 which is due to the farmer pursuant to the contract and the arrangement.

In addition to guaranteeing a net price 6 to be paid to the farmer 20 for completion of the production of the crop, this contract 7 would also guarantee that the net price 6 would be paid for a guaranteed minimum yield 5. Providing a guaranteed net price 6 and a guaranteed minimum yield 5 within the contract 7 provides the farmer 20 with forecastable revenue.

There are some additional key terms for the contract 7. In addition to providing for a guaranteed net price 6 to be paid to the farmer 20, on a volume basis, with respect to the crop yield 8 in question and a guaranteed minimum yield 5, the contract 7 would stipulate that the capital provider 21 would pay for the crop inputs 9 required during the crop season 2, and the capital provider 21 could be permitted to prescribe the agronomic plan 10 to be used in the production of the crop 4 in the crop production area 3 during the crop season 2. These additional contractual terms provide firstly for the minimization of capital requirements on the farmer 20, as well as the fact that the capital provider 21 would provide agronomic expertise to the farmer 20 targeted towards maximization of the crop yield 8 on the crop production area 3 in question within the crop season 2. The contract 7 would require that the farmer 20 accept and implement the agronomic direction provided by the capital provider 21.

To summarize them the following would be the key terms of the contract entered into between the farmer 20 and the capital provider 21:

Definition of the crop 4, crop production area 3, and crop season 2;

Agreement to a guaranteed minimum yield 5, on a volume basis, with respect to the production of the crop 4 within the crop production area 3 for the crop season 2;

Agreement on a volume-based net price 6 to be received by the farmer 20 with respect to the guaranteed minimum yield 5, as well as any additional yield of the crop 4 produced within the crop production area 3 for the crop season 2;

The farmer 20 to provide the labor to farm the crop 4 within the crop production area 3 for the crop season 2, in accordance with agronomic plan 10 to be prescribed by the capital provider 21; and

The capital provider 21 to pay for crop inputs 9 during the crop season 2.

Entry into this type of a contract 7, which includes these basic terms along with whatever other commercial terms the parties should elect to include, comprises step 1-2 of the method of the present invention. The business effect of the entry into this contract 7 is the establishment of the economic framework around which the capital provider 21 will finance the production of a crop on land owned or controlled by the farmer 20. Entry into the contract 7, shown at this step in FIG. 1, will take place in advance of the commencement of the relevant crop season 2.

Following entry into either a formal or informal contract for crop production on this basis, the farmer will plant the crop in accordance with the crop cycle 1 parameters at the commencement of the growing season. The capital provider throughout the growing season will pay for the required crop inputs, to the conclusion of the growing season and the harvest of the crop. Crop production and the harvest of the crop are shown at steps 1-5 and 1-6 respectively. Following the harvesting of the crop, the net payment due from the capital provider to the farmer is calculated in accordance with the details outlined above namely the net payment due will be the greater of the guaranteed minimum volume multiplied by the net price, and the net price multiplied by the actual volume of crop produced. The net payment due will likely be calculated by a crop production computer software program which contains the remainder of the crop cycle 1 parameters, the guaranteed volume yield 5 in the guaranteed net price 6 from the beginning of the transaction. That net payment amount due once calculated would be paid to the farmer—what effectively happens in this method is that the revenue for any produced volume over the guaranteed minimum yield 5 is shared between the capital provider in the farmer insofar as the farmer receives a net profit allocation as was agreed with respect to the remainder of the crop amount, and the remainder of the profit from the sale of the volume of product in excess of the guaranteed minimum yield would go to the capital provider as a financing margin or profit to their end of the business. The capital provider is also carrying the risk in this scenario of the pricing of the crop itself.

The final terms in the contract 7 between the farmer 20 and the capital provider 21 would provide that the farmer 20 would also be paid the guaranteed net price 6 in respect of any additional crop volume produced, which exceeded the guaranteed minimum yield 5. The farmer 20 then would share in the profitability of maximizing the crop output by implementation of best agronomic practices, and would be hedged by the guaranteed minimum yield 5 in the contract from crop failure or other risk factors.

Steps 1-7 through 1-9 of this Figure show the logic around the calculation of the net payment amount due 9, for payment to the farmer.

Following the completion of a particular crop season 2, the farmer 20 and the capital provider 21 could contract again for the next upcoming crop season 2. Environmental factors including the outcome of the implementation of the particular agronomic plan 10 may factor into changes in the guaranteed minimum yield 5 or the net price 6 in following contracts for production of the same crop 4 on the same crop production area 3 in a subsequent crop season 2.

It may also be the case that the farmer 20 and the capital provider 21 might contract for the production of a crop 4 on a particular crop production area 3 for multiple crop seasons 2 at the same time in a single contract—in the case of contracting for multiple crop seasons 2, the contract 7 itself may stipulate different net prices 6 or guaranteed minimum yields 5 in respect of different crop seasons 2, or they may all be the same—any such alterations and approach will be understood to be within the scope of the present invention.

It is specifically contemplated that the method of the present invention may include the capital provider also providing directly or indirectly access to agronomic consulting her best practices advice for the farmer to maximize the crop production within the defined crop cycle 1. It may either be a contractual term that the farmer needs to accept and follow such consulting or advice or it could be provided optionally—both such approaches as dependent modifications to the overarching method of the invention are contemplated herein.

### Crops:

There are many different types of agricultural crops which could be produced in accordance with the method of the present invention. It is specifically contemplated that any type of field or orchard crop which is grown within a particular fixed cropping cycle is contemplated within the scope of the present invention

### Crop Production Area:

As outlined above, the method of the present invention incorporates the concept of a crop production area. The crop production area as defined is contemplated to mean any particular field or group of fields or lands held by a farmer 20 and on or in respect of which a crop will be grown. From the perspective of establishing a guaranteed crop yield, it would be desirable in respect of a crop production area for the capital provider 21 to have access to some historical crop production statistics for the purposes of understanding and establishing the productivity of that particular land in the past.

A single farmer 20 may have multiple crop production areas within their farm and in fact within a particular single crop grown on a farm the land might be divided or considered as several distinct crop production areas if there is varying historical baseline production data which results in the need to segregate particular parcels of arable land or crop production space into specific discrete contracts, either from the purpose of establishing the guaranteed production volume, or the established net price for production. Different agricultural or agronomic factors may contribute to a different pricing structure within the model of the present invention with respect to distinct crop production areas of a single farmer 20, or alternatively it may be determined by the capital provider 21 and the farmer 20 to contract on the basis of the entire farm for production of a single crop being considered as a single crop production area, with the baseline historical data being averaged or otherwise considered along such lines. Treatment of the entirety of a particular crop land within a single farm as a single crop production area, or the division of the farm as pertains to a single crop into multiple crop production areas, resulting in multiple contracts in accordance with the method of the present invention, are both approaches which are contemplated within the scope of the present invention.

### Crop Season:

The crop season, in the case of many field crops, might be a calendar year. Other crops and dependent upon local environmental conditions, might be grown more than once per calendar year in which case the crop season 2 might actually comprise a portion of the year and there may be more than one crop season 2 within a calendar year. It will be understood that any crop season 2 of any length is contemplated within the scope of the present invention in so far as planning for the production of a crop 4 within such a crop season 2 is not depart from the concept and method outlined herein.

### Guaranteed Minimum Yield:

As outlined above, the method of the present invention provides for a guaranteed minimum yield-based payment for the farmer 20 from the capital provider 21 with respect to the production of the crop 4 within a particular crop season 2. Calculation of the minimum yield 5 which would be contracted for could be calculated using various factors including past historical yield data within the crop production area 3, weather forecasting or other external environmental variables which may impact the likely outcome of a particular crop season 2 and/or past farming practices of the farmer 20 within the crop production area 3. In any event, the contract 7 which would be agreed upon by the farmer 20 and the capital provider 21 in advance of commencement of the crop season 2 would provide for a guaranteed minimum yield calculation, based upon which a guaranteed minimum yield based revenue could be forecasted. Any number of different factors which could be used in the determination of the guaranteed minimum yield 5 are contemplated within the scope of the present invention.

### Net Price:

The contract 7, as outlined above, would provide for a net price 6 to be paid to the farmer 20 by the capital provider 21 in respect of the production of the crop 4 within the crop season 2. The net price 6 again might have many different factors in its calculation but at the end of the day would be agreed upon by the farmer 20 and the capital provider 21. The net price 6 would be paid to the farmer 20 with respect to the total yield 8 of the crop 4 within the crop production area 3 in the crop season 2, with a minimum payment guaranteed which equates to the net price 6 times the guaranteed minimum yield 5. If the total yield 8 of the crop 4 exceeded the guaranteed minimum yield 5, the net price 6 would be paid to the farmer in respect of the total yield 8, rather than in respect of the guaranteed minimum yield 5.

### Crop Inputs:

One of the key aspects of the economic model of the present invention is the fact that the capital provider 21 finances or pays for all of the crop inputs 9 which are necessary during the crop season 2 to produce the crop 4. By paying for the crop inputs 9, the capital provider 21 ensures the complete implementation of their agronomic plan 10 for the maximization of yield from the crop production area 3, as well as removing the capital requirements of the farmer 20 to pay for same. Crop inputs 9 might be hard goods or services—from seed, fertilizer, herbicides or pesticides etc. through to additional agronomic consulting, soil testing, equipment rental, crop testing or the like which might be required either before or during the crop season 2 to properly maximize the yield 8. It will be understood by those skilled in the art of farming and agricultural production practices that there are many different types of crop inputs which could be required or used in the production of a crop and all such products or services are contemplated within the scope of the definition of crop inputs 9 outlined herein, which might be financed or paid for by the capital provider 21 in the course of production of the crop 4 by the farmer 20 during a crop season 2.

The farmer and the capital provider could agree that certain inputs or farming costs would or would not be required crop inputs which would be covered by the capital provider within the scope of the transaction and the method of the present invention. It may for example be determined that certain aspects of the farmers operations for example carrying cost of financing and equipment etc. may not appropriately be considered to be input costs with respect to a particular crop cycle 1—or some pro rata portion might be allocated. There is flexibility in this aspect of the invention although conceptually it is contemplated that at least specific crop identifiable input costs would be financed by the capital provider within the scope of the present invention.

It may also be the case that the contract and the method could provide that the parties would agree that the amount of crop input costs which would be compensated or covered by the capital provider could be. They could either be With the farmer being directly responsible contemporaneously for paying any excess, or excess over the agreed-upon cap could be deducted from the net payment due 9 at the completion of the crop cycle 1.

### Example 1

### Production Less than Guaranteed Minimum Yield

For the purpose of demonstrating the underlying mathematics and business concept of the method of the present invention the following example is provided to demonstrate the outcome of the method of the present invention in a circumstance where there was either a crop failure or a shortcoming in the crop production below the anticipated minimum yield which was agreed between the parties at the time of the commencement of the crop cycle 1.

In this example, if the farmer and the capital provider agreed to the production of a wheat crop on 4000 acres of land over a single season, the following would be the crop cycle 1 parameters first determined and used:

Crop=wheat

Crop production area=4000 acres

Crop season=calendar year

Based upon past crop production on the fields in question or other external factors, it is agreed that the guaranteed minimum yield will be 6 bushels per acre. The volume based net price agreed upon between the parties is $2.50 per bushel. These last two formulae of variables then present themselves as follows:

Guaranteed minimum yield=24000 bushels

Net price=$2.50 per bushel

Calculated guaranteed minimum payment due=$60,000

Following contracting on this basis, the crop would be grown. In this circumstance at the conclusion of the crop year, 20,000 bushels of wheat was harvested and delivered to the capital provider by the farmer. Calculated based on the actual production times the net price, the net payment due would be $50,000. However given the guaranteed minimum yield in the contract, $60,000 would be the amount of the net payment due and made from the capital provider to the farmer.

### Example 2

### Excess Production

The following example is provided to demonstrate the outcome of the method of the present invention in a circumstance where there was crop grown and produced in excess of the minimum yield guarantee. If the farmer and the capital provider agreed to the production of a wheat crop on 4000 acres of land over a single season, the following would be the crop cycle 1 parameters first determined and used:

Crop=wheat

Crop production area=4000 acres

Crop season=calendar year

Based upon past crop production on the fields in question or other external factors, it is agreed that the guaranteed minimum yield will be 6 bushels per acre. The volume based net price agreed upon between the parties is $2.50 per bushel. These last two formulae of variables then present themselves as follows:

Guaranteed minimum yield=24000 bushels

Net price=$2.50 per bushel

Calculated guaranteed minimum payment due=$60,000

Following contracting on this basis, the crop would be grown. In this circumstance at the conclusion of the crop year, 50,000 bushels of wheat was harvested and delivered to the capital provider by the farmer. Calculated based on the actual production times the net price, the net payment due would be $125,000. Since then that payment due based on the actual volume calculation exceeds that of the guaranteed minimum yield, $125,000 would be the net payment due from the capital provider to the farmer, and the capital provider would then as in other implementations are embodiments of the invention further handle or sell the product as they see fit.

### Agronomic Plan:

One of the key benefits and requirements of the method of the present invention is that the capital provider 21 may provide to the farmer 20 agronomic direction and best practices to maximize the crop output or total yield 8 from the crop production area 3. Farmers 20 might otherwise not always have access to the best available agronomic advice and this will be a benefit of the method of the present invention to the farmer, in addition to assisting both the farmer 20 on the capital provider 21 to maximize their economic return from the method of the present invention.

As outlined above, the capital provider 21 will provide agronomic direction and plans to the farmer 20, and the contract 7 will require that the farmer 20 implement the agronomic direction provided by the capital provider 21. A crop production plan 10 may be developed and simply communicated to the farmer 20 by the capital provider 21 in advance of or coincident with the commencement of the crop season 2, and/or ongoing agronomic advice may also be provided. As outlined above, the provision of agronomic or crop production direction and advice, for implementation by the farmer 20 from the capital provider 21 on either a preliminary or ongoing basis are all contemplated within the scope of the present invention.

### Crop Production Computer Software:

At the core of the present invention is the development and use of a crop production computer software in the implementation of the method of the present invention. The crop production computer software would be used to capture and calculate the crop cycle parameters at the front end of a particular transaction between a farmer in the capital provider, as well as to potentially calculate the final net payment due at the tail end of a crop cycle for payment to the farmer.

As outlined elsewhere herein, crop production computer software could be used in the rendering of the method of the present invention. There are two steps in the method of the present invention in which the use of computer software would be optimal or desirable from the perspective of enhancing the performance of the method. The first stage is at the front end of the process in the definition and scoping of the crop cycle 1 itself and the second is at the tail end of the process at the completion of the crop cycle 1, where the calculation of the net payment due from the capital provider to the farmers calculated for rendering.

Referring to FIG. 2 there is shown a step diagram which demonstrates the steps which would be conducted by a crop production computer software in the implementation of some embodiments of the present invention. The computer software, executed in either a local or client/server format, would effectively allow a user, being either the capital provider or the farmer, or both of them, to enter certain data therein. The data that would first be captured would relate to the crop cycle 1 parameters and more specifically the selection of the crop 2, the crop production area 3, and/or the actual details of the crop growth season 4. These are the parameters which are required to define the crop cycle 1 from the larger perspective of the method of the present invention and each of these parameters and their details are outlined elsewhere herein. The capture of the crop cycle 1 parameters is shown at step 2-1.

Following the capture or data entry of the crop cycle 1 parameters by a user, the crop production computer software would then generate the guaranteed minimum yield 5 in respect of the crop cycle 1 which is defined by the parameters entered by the users. The guaranteed minimum yield 5 could be generated by the data entry by a user, and/or could also be calculated by the crop production computer software by drawing on other related data sources such as for example if the crop production computer software had stored therein or accessible thereto a dataset which outlined past crop production levels with respect to the particular crop production area 3 and the growth of the selected crop 2 thereon. The guaranteed minimum yield 5 would be calculated in accordance with any number of specific formulas which would be understood by agronomists or programmers skilled in the art of this area and all such approaches are contemplated within the scope hereof. Capture or calculation of the guaranteed minimum yield 5 is shown at step 2-2.

The final detail of a particular transaction pursuant to the method of the present invention which is necessary for the conclusion of a contract and the entry into a particular crop cycle 1 in accordance with the method of the present invention is the determination or calculation of the net price 6. Net price 6 as outlined above is a volume based figure which is agreed upon between the parties being the farmer and the capital provider, and which effectively prescribes the profit per volume unit which the farmer will be paid for growing the crop. The net price 6 could be simply data entered by user to the crop production computer software, or more likely would be calculated by drawing that information from a dataset contained in or accessible to the crop production computer software which was a series of net prices 6 calculated by the capital provider which they were prepared to pay for the future production of the crops 2—these would likely have been calculated based on some hedging and market forecast calculations with respect to the market forecast for the pricing of the crops 2 towards the end of the growing season in question. To accommodate different farming practices in different farmers, the crop production computer software may calculate the net price 6 based upon a final anticipated market price for the product from which the anticipated crop input costs from the particular user combination and particular crop cycle 1 as defined were deducted. There are again many different ways of calculating the net price 6, based upon a pure formulaic calculation or based upon a series or a dataset contained therein from which the appropriate net price 6 per volume could be selected. Calculation or determination of the net per volume price 6 is shown at Step 2-3.

The final step which would be executed by the crop production computer software at the front-end of the crop production process in accordance with the method the present invention would be the rendering of an actual contract between the farmer and the capital provider, based upon the calculated crop cycle 1 parameters and figures described above. The actual generation of a document, and various document assembly tools, will be understood to those skilled in the art of computer programming and so many different approaches could be taken and all are contemplated within the scope hereof. The rendering of the contract for presentation or printing by the parties for execution is an optional step insofar as the crop production computer software might also simply capture and calculate the necessary figures and display them to the users for manual entry into a printed contract but it is likely the case that one way or the other the parties are going to wish to enter into a written binding contract to solidify the nature of their crop production transaction in accordance with the remainder of the present invention and the crop production computer software could render that document and display or provide it to the users for subsequent handling. Generation of the contract is shown at Step 2-4.

FIG. 2 shows one very basic flow diagram of the steps that a business level which would be conducted by the crop production computer software in accordance with the present invention. It will be understood that the functionality of this type of software could be delivered in many different forms and by many different programming approaches and all such approaches which accomplish the same objective of providing a computer-assisted method of the calculation and capture of these figures and parameters is contemplated within the scope hereof. For example it is contemplated that in certain circumstances the crop production computer software of the present invention might comprise a spreadsheet with the necessary calculations built therein, through to a more elaborate implementation of a crop production computer software which was a freestanding software which included one or more connections to data sources which were used to render more elaborate or refined calculations of the guaranteed minimum yield 5 or the net price per volume 6.

Referring quickly to FIG. 3, there is shown a basic flow diagram of the steps which would be conducted by a crop production computer software at the conclusion of a crop growing cycle 1. Shown at step 3-1, the crop production computer software would capture from the user the actual amount of produced crop with respect to a particular defined crop cycle 1. Based upon the amount of the crop produced, as well as the guaranteed minimum yield 5, the crop production area 4 and the net price 6 previously agreed between the farmer in the capital provider, the crop production computer software would then calculate the amount of the net payment due based upon whether or not the crop production exceeded the guaranteed minimum yield 5. Those calculations are shown above in Examples 1 and 2.

FIG. 4 illustrates one example of the type of a computer or computer system 20 that can be used in accordance with or to implement various embodiments discussed herein. It is appreciated that the computer system 20 of this Figure is only an example in the embodiments as described herein can operate on or within number of different computer systems including, but not limited to, general-purpose network computer systems, embedded computer systems, server devices, client devices, standalone or cloud computing systems and the like.

The system of FIG. 4 shows a computer 20 which includes a CPU 25, along with read-only memory 26 and random access memory 27 and a storage device 28, all of which are connected by a boss 30. There is also shown an input-output device 29 which could be connected either to the bus or otherwise, to allow for data entry from a user such as a keyboard or the like—or a monitor or printer to allow for data output. Many different types of conventional input and output devices can be contemplated and will be understood within the scope hereof by those skilled in the art of computer systems design. Shown as well is the series of computer instructions which would be saved in the storage or the memory of the system to allow it to conduct the method of the present invention or other tasks for which was used. For example the operating system 22 is shown along with an application storage area 24 which would comprise the necessary processor instructions for the computer 20 to execute various applications for a user. Also shown is a data store 23 in a database 22—these are shown for demonstrative purposes to demonstrate the different types of data storage approaches which could be taken with respect to the crop production computer software the present invention. It will be understood that the computer system of FIG. 4 is really shown only for demonstrative purposes herein and that there are many different types of approaches and hardware which could be used in conjunction with a crop production computer software which would accomplish the necessary objectives of the present invention and all such approaches are contemplated within the scope hereof. In a more elaborate software embodiment it could even be possible that the crop production computer software of the present invention could be delivered in a client/server or ASP format with remote or wide area connectivity.

The foregoing is considered as illustrative only of the principles of the invention. Thus, while certain aspects and embodiments of the invention have been described, these have been presented by way of example only and are not intended to limit the scope of the invention. Indeed, the invention described herein may be embodied in a variety of other forms without departing from the spirit of the invention, which invention is defined solely by the claims herein.

We claim:

1. A method of production of an agricultural crop within a crop season by a farmer and a capital provider, said method comprising the following steps:
a. before commencement of the crop season:
i. defining a crop cycle, being a crop to be grown in a particular crop season on a crop production area;
ii. defining a guaranteed minimum volume yield for the defined crop cycle; and
iii. defining a volume based net price to be paid to the farmer; and
iv. creating a contract between the farmer and the capital provider for sale of the crop produced during the crop cycle, wherein the capital provider agrees to pay a net payment being the greater of the following to the farmer upon delivery of the crop at completion of the crop cycle:
ii. the guaranteed minimum volume multiplied by the net price; and
ii. the net price multiplied by the actual volume of crop produced;
and wherein the capital provider agrees to pay for all of the required crop inputs during the crop cycle;
b. on commencement of the crop season of the crop cycle, the farmer planting and proceeding with production of the crop throughout the crop season, wherein during the crop cycle the capital provider pays for all required crop inputs;
c. at the conclusion of the crop season:
i. harvesting the crop and selling from the farmer to the capital provider all of the crop produced in the crop cycle;
ii. Calculating the net payment due from the capital provider to the farmer, based on the contract; and
iii. Rendering the net payment due from the capital provider to the farmer.

2. The method of claim 1 wherein the crop cycle is defined and the guaranteed minimum volume yield and volume based net price are calculated or recorded using a crop production computer program.

3. The method of claim 2 wherein the contract is physically created for execution by the farmer and the capital provider by the crop production computer program.

4. The method of claim 1 wherein the guaranteed minimum volume yield is calculated based on historical production volumes for the crop production area.

5. The method of claim 2 wherein the crop production computer program includes historical production volumes for the crop production area, and wherein said historical production volumes are used by the program in calculating the guaranteed minimum volume yield.

6. The method of claim 1 wherein the contract includes a cap on the amount of required crop inputs which will be paid for by the capital provider.

7. The method of claim 1 wherein the net payment due from the capital provider to the farmer is calculated by a crop production computer program.

8. The method of claim 1 wherein the required crop inputs which will be paid for by the capital provider are defined in the contract.

9. A method of production of an agricultural crop within a crop season by a farmer and a capital provider, said method comprising the following steps:
a. before commencement of the crop season:
i. inputting the parameters of a crop cycle, being a crop to be grown, the duration or particulars of a particular crop season, and a crop production area, into a crop production computer program;
ii. based on the crop cycle parameters input, using the crop production computer program generating a guaranteed minimum volume yield for the defined crop cycle, and a volume based net price to be paid to the farmer; and
iii. generating a contract between the farmer and the capital provider for sale of the crop grown in the defined crop and stipulating the generated guaranteed minimum volume yield and net price determined by the crop production computer program, wherein the capital provider agrees to pay a net payment being the greater of the following to the farmer upon delivery of the crop at completion of the crop cycle:
a. the guaranteed minimum volume multiplied by the net price; and
b. the net price multiplied by the actual volume of crop produced;
and wherein the capital provider agrees to pay for all of the required crop inputs during the crop cycle;
b. following execution of the contract, the farmer planting and proceeding with production of the crop through the defined crop cycle, wherein during the crop cycle the capital provider pays for all required crop inputs;
c. at the conclusion of the crop season:
i. the farmer transferring to the capital provider all of the crop produced in the crop cycle; and
ii. Using a crop production computer program, calculating the net payment due from the capital provider to the farmer based on the contract.

10. The method of claim 8 wherein the crop production computer program includes a database of historical production volumes for the crop production area, and wherein said historical production volumes are used by the crop production computer program in calculating the guaranteed minimum volume yield.

11. The method of claim 8 wherein the contract includes a cap on the amount of required crop inputs which will be paid for by the capital provider, and wherein any amounts paid by the capital provider in excess of the cap are deducted from the net payment due when calculated by the crop production computer program.

12. The method of claim 1 wherein the required crop inputs which will be paid for by the capital provider are defined in the contract.

13. A method of formation of a contracted agricultural production transaction between a farmer and a capital provider before commencement of a crop season, said method comprising the following steps:
a. inputting the parameters of a crop cycle, being a crop to be grown, the duration or particulars of a particular crop season, and a crop production area, into a crop production computer program;
b. based on the crop cycle parameters input, using the crop production computer program generating a guaranteed minimum volume yield for the defined crop cycle, and a volume based net price to be paid to the farmer; and
c. generating a contract between the farmer and the capital provider for sale of the crop grown in the defined crop and stipulating the generated guaranteed minimum volume yield and net price determined by the crop production computer program, wherein the capital provider agrees to pay a net payment being the greater of the following to the farmer upon delivery of the crop at completion of the crop cycle:
i. the guaranteed minimum volume multiplied by the net price; and
ii. the net price multiplied by the actual volume of crop produced;
and wherein the capital provider agrees to pay for all of the required crop inputs during the crop cycle.

14. The method of claim 13 wherein the contract for execution between the farmer and the capital provider is physically generated by the crop production computer program.
